(19) United States
(12) Patent Application Publication
(10) Pub. No.: US 2005/0160698 A1
(43) Pub. Date: Jul. 28, 2005

(54) Capsule-sealing machine for food or drink containers

(75) Inventor: Dangher Caffeo, Casalecchio Di Reno (IT)

Correspondence Address: EGBERT LAW OFFICES, 412 MAIN STREET, 7TH FLOOR, HOUSTON, TX, 77002, US

(73) Assignee: ECOCAP'S S.R.L., Casalecchio di Reno (IT)

(21) Appl. No.: 10/512,749

(22) PCT Filed: Nov. 19, 2002
(86) PCT No.: PCT/IT02/00732

(30) Foreign Application Priority Data
May 28, 2002 (IT) BO02A000325

(51) Int. Cl. B65B 7/28; B67B 1/03

(52) U.S. Cl. 53/290

(57) ABSTRACT

The machine to which this invention pertains is an automatic apparatus that uses a heat-sealing process to apply sterile aluminum blank capsules on food or drink containers defined as “tins” or “cans”, preferably cylindrical in shape but also square, rectangular or oval.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present industrial invention regards an automatic machine that uses a heat-sealing process to apply a sterile aluminum capsule on food or drink containers defined as “tins” or “cans”, preferably cylindrical in shape but also square, rectangular or oval.

### BACKGROUND OF THE INVENTION

With specific reference to apparatuses of this kind presently available on the market, it may be affirmed that numerous types exist, each classifiable according to the speed at which the capsule is applied and above all the nature of the capsule used.

### BRIEF SUMMARY OF THE INVENTION

The present invention regards a highly productive machine that heat seals a single-material aluminum capsule “bonded” with lacquer on the existing can cover (the use of said heat-sealing procedure having been claimed in the applicant's patent no. 01310415). It is distinguished by the innovative solutions devised for the capsule magazine, for picking up and transferring the capsules and raising the can, as well as for the sealing head which seals the capsules on the can rim.

### BRIEF DESCRIPTION OF THE SEVERAL VIEWS OF THE DRAWINGS

These and other features will now become more evident in the description of a simple form of execution of the invention, which serves purely illustrative purposes and in no way limits the scope of this patent.

Referring to the enclosed diagrams, where:

FIG. 1 shows the machine layout.

FIG. 2 shows the assembly of the different units which are integral parts of the machine.

FIG. 3 shows the previous assembly, with letters of reference identifying the components.

FIG. 4 shows the capsule magazine unit.

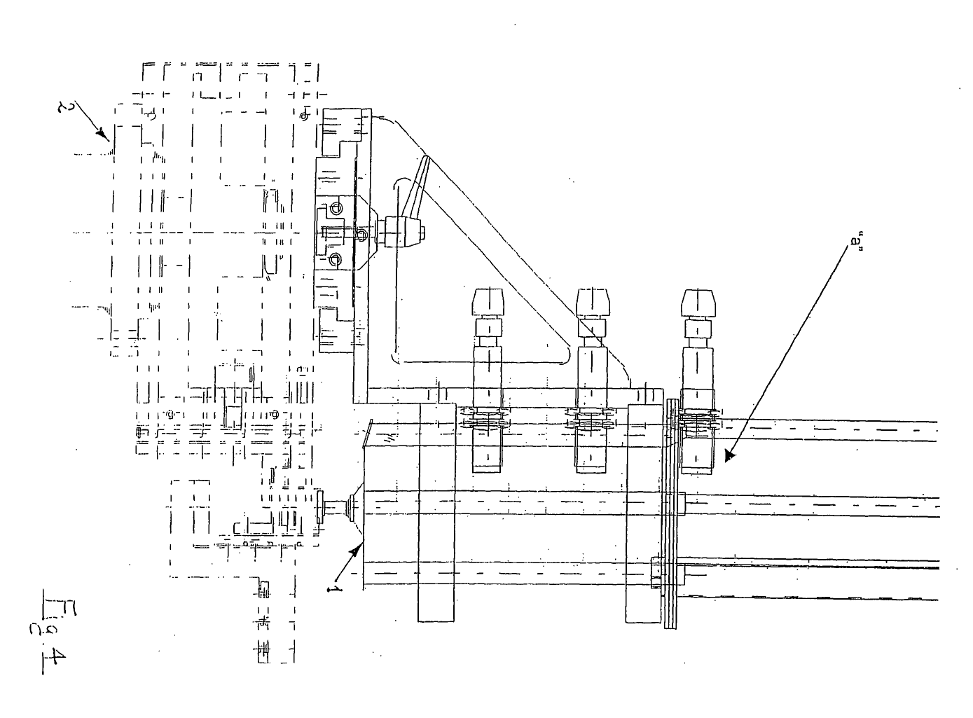

FIG. 5 shows the capsule pick-up and transfer unit.

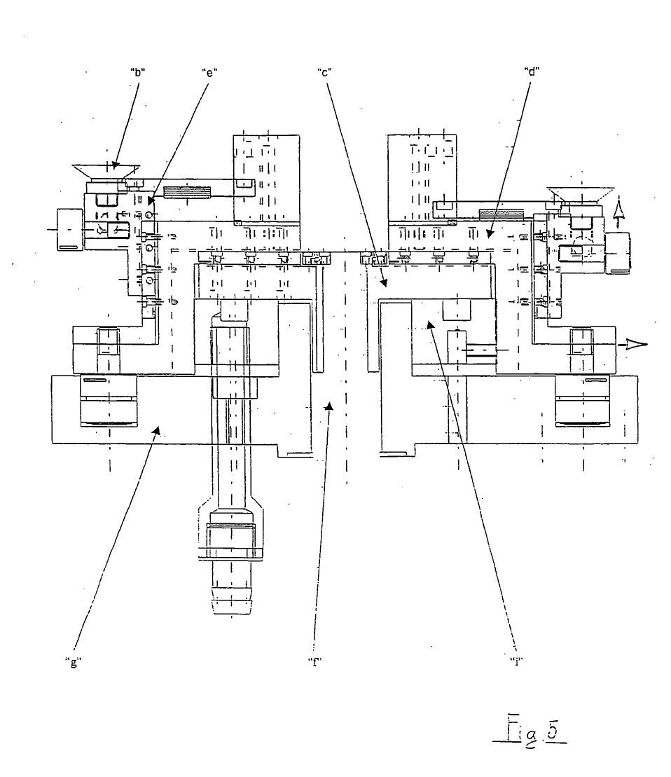

FIG. 6 shows the capsule pick-up and transfer unit as seen from above.

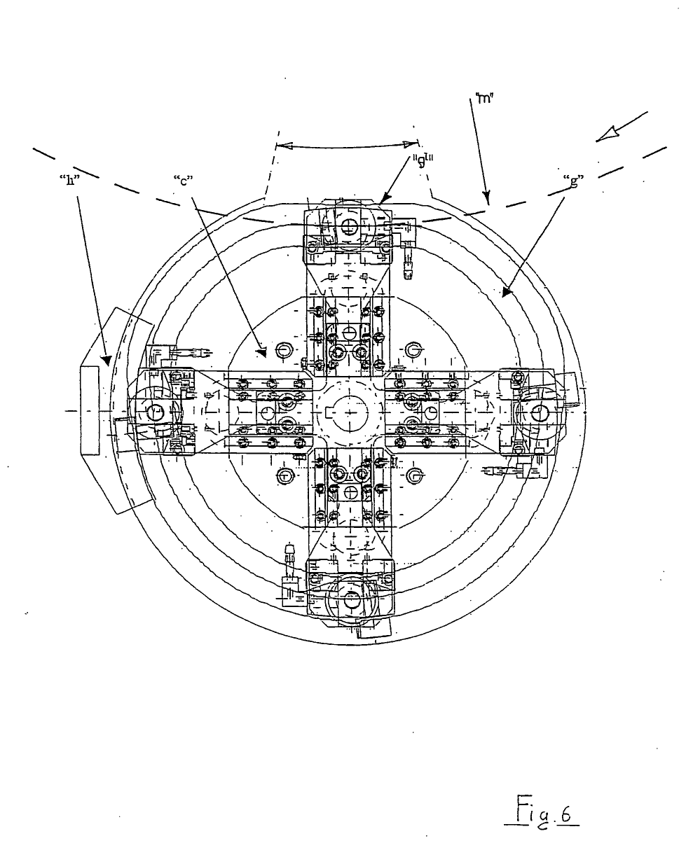

FIG. 7 shows the can-elevating unit.

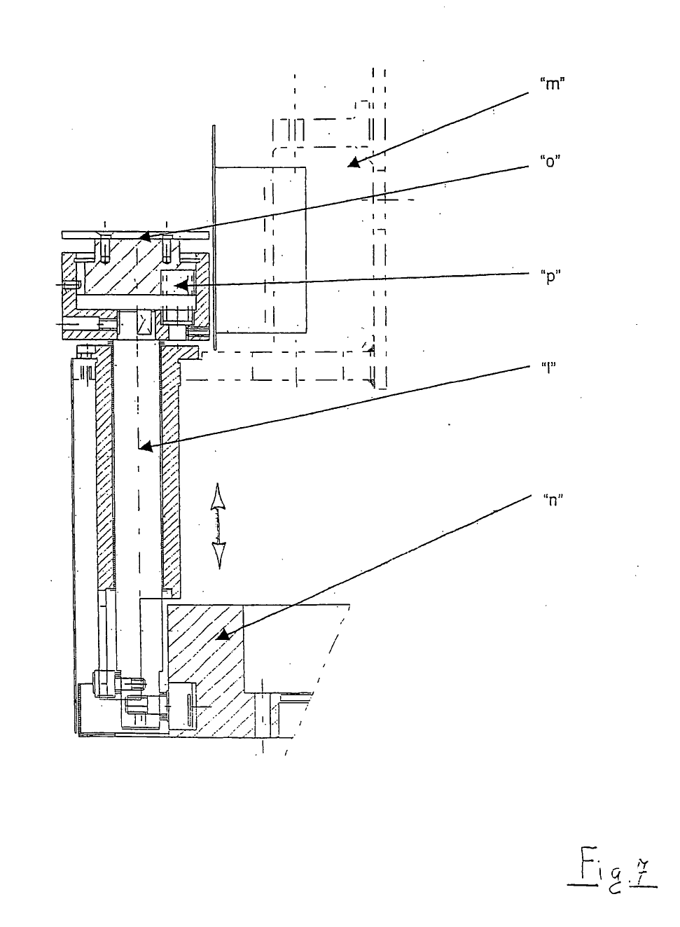

FIG. 8 shows the sealing head unit.

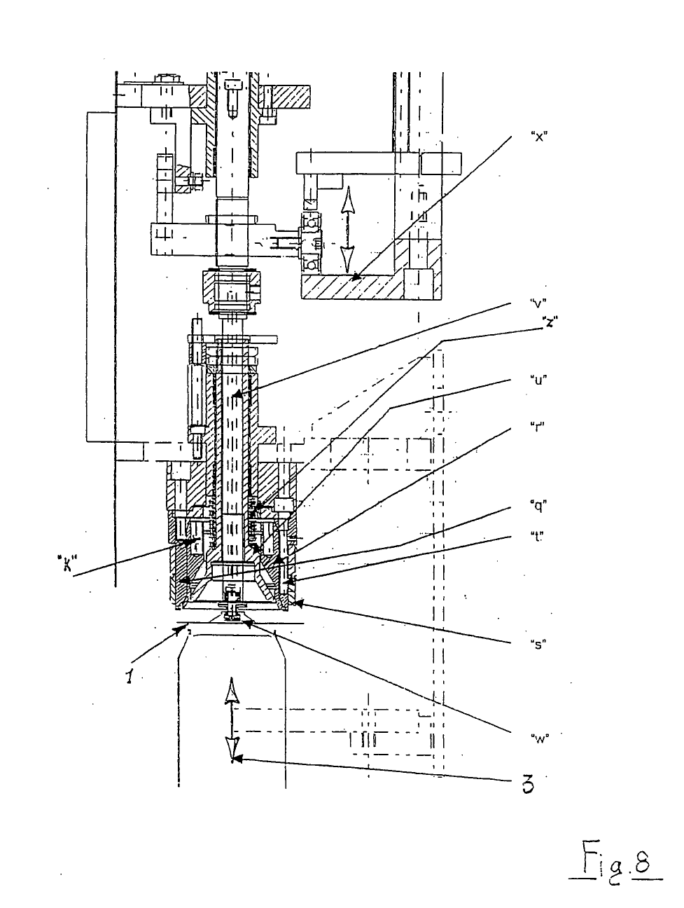

### DETAILED DESCRIPTION OF THE INVENTION

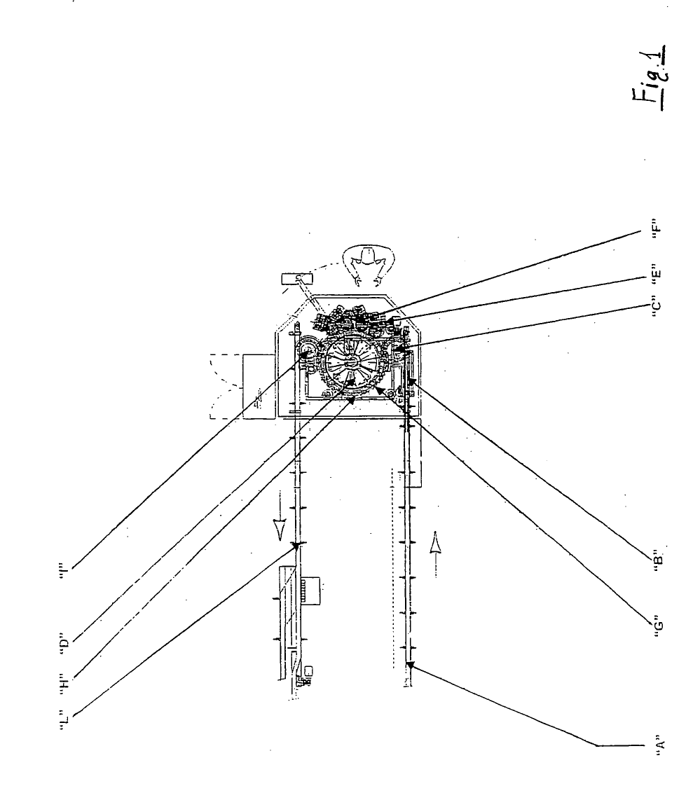

Referring to FIG. 1, the letter “A” indicates the belt that conveys cans to the machine, which, by means of a screw “B”, spaces them apart and conveys them to a first carousel “C”, which transfers them to the main carousel “D”, where the capsules are sealed onto the can covers. The capsules are contained in vertical magazines “E”. Actuated by the pick-up units “F”, a series of suction cups removes the capsules from the magazines and passes them to another series of suction cups located inside the sealing heads “G”.

In the main carousel (“D”) the cans are raised by the elevating units “H” and come into contact first with the capsules and then with the sealing head (“G”). At the end of the sealing process the cans are transferred to a third carousel “I” and conveyed to the outfeed belt “L”.

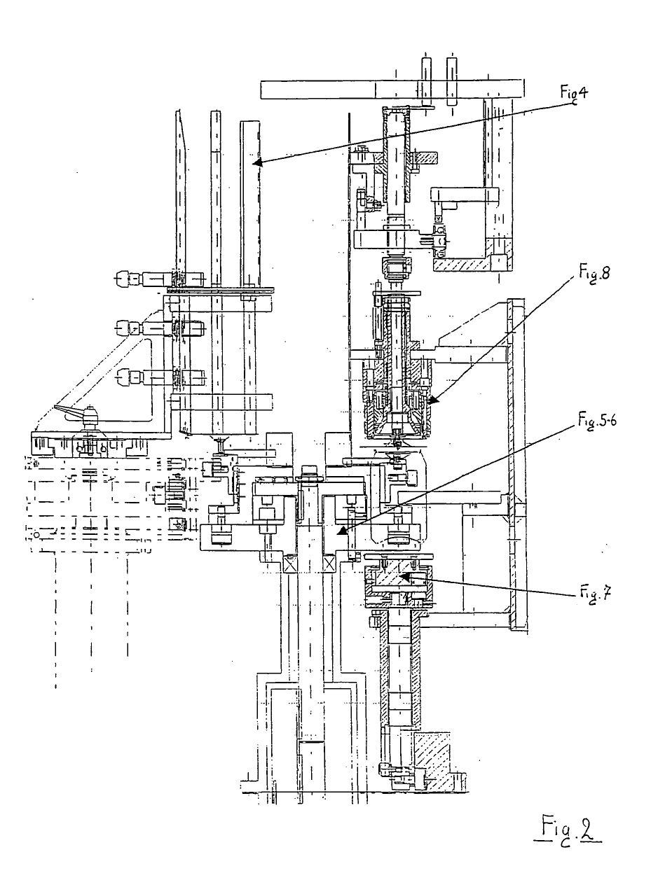

FIG. 2 shows the assembly of the different units which are integral parts of the machine.

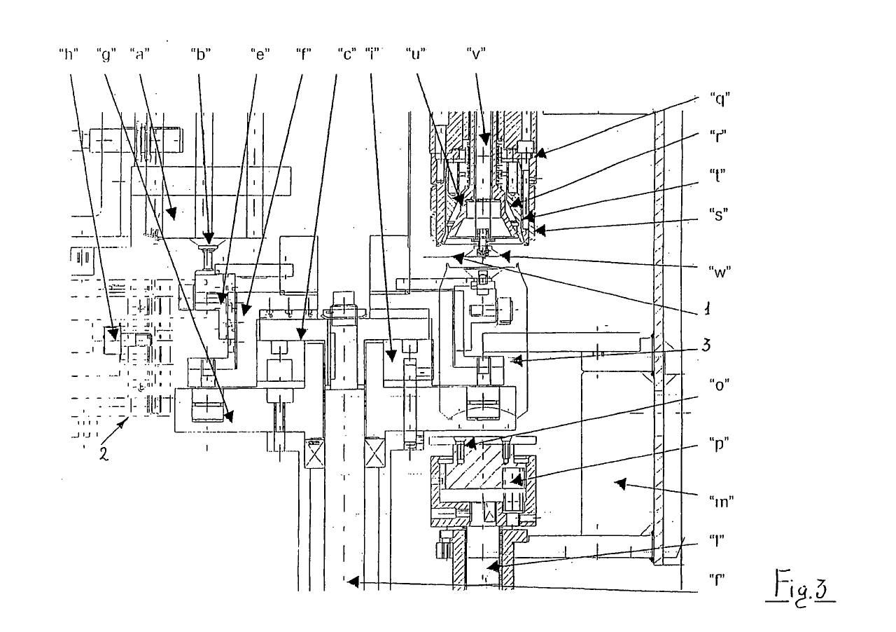

Reference is made to FIGS. 3,4, 5,6, 7,8), according to the operations described.

As shown in FIGS. 3,4, the blanks 1 are contained in the vertical magazine “a” and are kept in place by a series of “claws” which prevent them from slipping. The magazine is fixed on level 2 of the machine.

As shown in FIGS. 3,5, 6, the pick-up unit comprises a main platform “c” bearing carriages “d” and “e”, which travel respectively along a horizontal and vertical axis.

Suction cups “b” are mounted on carriage “e”.

The platform (“c”) is moved by a multi-positionintermitter “f” driven by the main machine motor. During a dwell of the intermitter, the cam “h” turns and brings suction cup “b” mounted on carriage “e” into contact with the capsules (1) contained in the magazine (“a”).

The suction cup (“b”) is connected to a vacuum pump by means of a grooved cam “i” and during the dwell of cam “h” it holds the capsule (1) by suction. During the descent of the carriage (“e”), which is moved by the cam (“h”), the capsule (1) held by suction is pulled from the magazine and continues to adhere to the suction cup (“b”).

At this point the intermitter (“f”) starts to turn, drawing with it the platform (“c”) and all the parts integral with the latter.

The fixed cam “g” has a grooved section of length “g′” with a diameter matching that of the main carousel “m”.

As the platform (“c”) turns, the carriages (“d”) travel horizontally outward, their motion being constrained by the cam (“g”), and “copy” the diameter of the main carousel (“m”) bearing the sealing heads for the length “g′”. Since in that copying phase the speed of the intermitter is equal to the rotation speed of the carousel (“m”), no relative motion occurs between suction cup “b” and suction cup “w” situated inside the sealing head.

The suction cup (“w”) is integral with shaft “v” and is connected to a vacuum pump by means of a grooved cam. For the copying length of the path followed by the suction cup (“b”), fixed cam “x” causes suction cup “w”, with the vacuum activated, to detach the capsule from suction cup “b”. The capsule's transfer from one suction cup to the other is facilitated by the fact that during the copying phase the vacuum deactivated in the suction cup (“b”) is replaced by a jet of compressed air delivered by means of the grooved cam (“i”). At this point suction cup “w” of cam “x” turns together with the carousel (“m”) and moves away from suction cup “b”, taking the capsule (1) with it. The operation is repeated between the next suction cup “b” and suction cup “w” of the next sealing head.

As shown in FIGS. 3,7, the can-elevating unit indicated by the number 3 comprises an elevator “I” fixed to the main carousel (“m”).

Plate “o”, integral with the elevator, is the surface the can (3) rests on.

The elevator's movement is constrained by cam “n” and during the rotation of the carousel (“m”) it raises the can until it comes up against the sealing head. The plate (“o”) floats, resting upon springs “p”. When the elevator (“I”) rises, bringing the can (3) into contact with the sealing head, the springs (“p”) are compressed and exert the necessary thrust to seal the capsule (1).

As shown in FIGS. 3,8, the sealing head, integral with the main carousel (“m”), comprises a central element “q” heated by a pair of heating elements “s” controlled by the temperature sensor “t”.

Each of the two heating elements has enough power to seal the capsule; therefore should one heating element fail, an electronic system automatically cuts it out and activates the second heating element. This guarantees the continuity of the machine's operation.

Inside the central element (“q”) there is a second mobile element “r”, and situated inside the latter is a capsule press-forming device “u”. The pressing device (“u”) travels along the shaft (“v”) bearing the suction cup (“w”) and is held in position by a spring “z”.

The mobile element (“r”) is made up of several independent sectors to compensate the geometrical tolerances in the can's shape and produce a seal both on the top rim and the outer side edge of the can; it runs inside the central element (“q”) and is held in place by a series of springs “k”.

When the can (3) rises, conveyed by the elevating unit, it meets the capsule (1) retained by the suction cup (“w”).

At this point the shaft (“v”) moved by the cam (“x”) likewise starts to rise, copying the ascent of the can.

The can (3) continues to rise until it meets the six mobile elements (“r”).

The capsule (1), which is now compressed between the can (3) and the press-forming device (“u”), assumes the shape of the inside of the can cover and adheres to the outside of the cover itself, compressed against the mobile elements (“r”).

The can (3) continues to rise, pushing the mobile sectors (“r”) upward until the cam (“n”) reaches the upper travel limit and the springs (“p”) are duly compressed. The mobile sectors (“r”), opposed by the position springs (“k”), slide along the cone of the central casing (“q”) and clamp the capsule (1) against the outer edge of the can, which is in turn pushed by the springs (“p”).

Therefore, throughout the dwell of the cam (“n”) in the raised position, the can (3) is pressed against the capsule (1), which is in turn pressed against the mobile elements (“r”); the latter, being heated, generate a seal both on the top and side of the can.

At the end of the cam (“n”) dwell, the can-elevating unit descends, taking with it the sealed can (3), which is then released and conveyed to subsequent processing lines.

1. Capsule-sealing machine for food or drink containers comprising;
a conveyor belt, a screw feeder, a first carousel, a main carousel, capsules sealed onto can covers, a capsule magazine, capsule pick-up units, elevating units, sealing heads, a third carousel and an outfeed belt
wherein said capsule magazine, being made integral with a machine surface, has a vertical structure with retaining claws to control descent of blanks
wherein said capsule pick-up unit has a main platform bearing horizontally and vertically travelling carriages, and a suction cup mounted at an extremity of said main platform,
wherein the platform is moveable by a multi-position intermitter driven by a main machine motor,
wherein a cam brings the suction cups into contact with the capsule, during turning of said cam and dwell of the intermitter, wherein said suction cups is connected to a vacuum pump by of a grooved cam
wherein a fixed cam has a grooved section of a length with a radius equal to a main carousel,
wherein during rotation of the main platform, the carriages travel horizontally, motion of the carriages being constrained by the cam, and copying a diameter of the carousel for said length,
wherein speed of the intermitter during a copying phase is equal to rotation speed of the carousel, wherein no relative motion occurs between a first suction cup and a second suction cup situated inside a sealing head, wherein the second suction cup is made integral with the shaft and is connected to a vacuum pump by the grooved cam,
wherein in copying said length of a path traveled by the first suction cup, the fixed cam descends the second suction cup until the second suction cup contacts the first suction cup, wherein, during the copying, the second suction cup deactivates the vacuum and replaces the vacuum with a jet of compressed air delivered by the grooved cam, wherein the second suction is moveable away by the cam,
wherein said can-elevating unit employs an elevator fixed to the main carousel and a supporting plate integral with the elevator, wherein motion of the elevator is constrained by the cam, wherein the plate floats and rests upon springs providing necessary thrust during a sealing phase,
wherein a sealing head unit integral with the main carousel employs a central element heated by a pair of heating elements controlled by a temperature sensor and functioning autonomously,
wherein inside a central element, a second mobile element contains a capsule-shaped pressing device wherein the pressing device, which travels along the shaft bearing the suction cup, is held in place by a spring, wherein the mobile element comprises a number of independent sectors serving to compensate tolerances in can shape and, being heated, to seal a capsule both on a top rim and upper side edge of the can, wherein the mobile element is slidable along a conical inside of the central element and is held in position by a series of springs, wherein the cam determines an upper travel limit of the can.
